(19) United States
(12) Patent Application Publication
(10) Pub. No.: US 2011/0157211 A1
(43) Pub. Date: Jun. 30, 2011

(54) DISPLAY CONTROL DEVICE AND DISPLAY CONTROL METHOD

(75) Inventors: Tohru Nakahara, Osaka (JP); Nobuhiro Kambe, Kanagawa (JP)

(73) Assignee: PANASONIC CORPORATION, Osaka (JP)

(21) Appl. No.: 13/062,587

(22) PCT Filed: Aug. 4, 2010
(86) PCT No.: PCT/JP2010/004904

§ 371 Date: Mar. 7, 2011

(30) Foreign Application Priority Data
Aug. 10, 2009 (JP) 2009-185840

(51) Int. Cl. G09G 5/02; G09G 5/00

(52) U.S. Cl. 345/589; 345/660

(57) ABSTRACT

Disclosed is a display control apparatus that enables a plurality of users to view their respective desired content simultaneously while suppressing a sacrifice of screen size. In a display control section (204), a content screen display section (2041B) controls a display position and display size in an overall screen area for a plurality of content screens that display respective content so that each content display screen includes an occupied area that does not overlap another content screen, and generates and outputs display data of the plurality of content screens. A determination section (2043) determines whether or not one content screen displayed in a predetermined occupied area from among a plurality of occupied areas has been identified by a user. The content screen display section (2041B) generates display data for performing superimposed display of the plurality of content screens in an area larger than an occupied area based on a determination result of the determination section (2043).

### TECHNICAL FIELD

The present invention relates to a display control apparatus and display control method that display a plurality of content screens.

### BACKGROUND ART

In recent years, systems that distribute digital copyrighted works such as music, video, games, and the like, have been developed and reached the stage of commercialization.

At the same time, CRT (Cathode Ray Tube) displays continue to be replaced at a rapid pace by terrestrial digital broadcast capable PDP (Plasma Display Panel), liquid crystal, and suchlike large-screen flat-panel TVs. As domestic TV screens become larger, the TV viewing environment is also changing, and an increasing demand is foreseen in the future for each of a plurality of users sharing a single display to be able to view different content items, such as music, video, and games.

Display apparatuses that display a plurality of content screens on a single display have been disclosed in Patent Literature 1 and Patent Literature 2, for example.

### CITATION LIST

### Patent Literature

PTL 1
Japanese Patent Application Laid-Open No. 1982-109477
PTL 2
Japanese Patent Application Laid-Open No. 1996-46889

### SUMMARY OF INVENTION

### Technical Problem

However, with a conventional display apparatus, the display screen area is divided into a plurality of screens, and different content is displayed on each of these screens. Consequently, individual users view their respective desired content items in a state in which the screen area is reduced, and, despite the fact that the screen area of the display apparatus itself is large, when a plurality of users wish to view different content items simultaneously, each user has to sacrifice screen size.

It is therefore an object of the present invention to provide a display control apparatus and display control method that enable a plurality of users to view their respective desired content items simultaneously while suppressing a sacrifice of screen size.

### Solution to Problem

A display control apparatus of the present invention controls display of a plurality of content items, and has: a content screen display section that controls a display position and display size in an overall screen area for a plurality of content screens that display respective content items so that each content display screen includes an occupied area that does not overlap another content screen, and generates and outputs display data of the plurality of content screens; and a determination section that determines whether or not one content screen displayed in a predetermined occupied area from among a plurality of the occupied areas has been identified by a user; wherein the content screen display section generates display data for performing superimposed display of the plurality of content screens upon an area larger than the occupied area based on a determination result of the determination section.

A display control method of the present invention controls display of a plurality of content items, and has: a screen display step of controlling a display position and display size in an overall screen area for a plurality of content screens that display respective content items so that each content display screen includes an occupied area that does not overlap another content screen, and generating and outputting display data of the plurality of content screens; and a determination step of determining whether or not one content screen displayed in a predetermined occupied area from among a plurality of the occupied areas has been identified by a user; wherein the screen display step generates display data for performing superimposed display of the plurality of content screens upon an area larger than the occupied area based on a determination result of the determination step.

### Advantageous Effects of Invention

The present invention enables a plurality of users to view their respective desired content items simultaneously while suppressing a sacrifice of screen size.

### BRIEF DESCRIPTION OF DRAWINGS

FIG. 1 is a drawing showing the overall schematic configuration of an information display system according to Embodiment 1 of the present invention;

FIG. 2 is a block diagram showing the configuration of a content distribution server according to Embodiment 1 of the present invention;

FIG. 3 is a block diagram showing the configuration of a display apparatus according to Embodiment 1;

FIG. 4 is a drawing showing the table configuration of a content storage section according to Embodiment 1;

FIG. 5 is a drawing showing the table configuration of a content information storage section according to Embodiment 1;

FIG. 6 is a flowchart showing [Display Method #1] according to Embodiment 1;

FIG. 7 is a drawing for explaining [Display Method #1] according to Embodiment 1;

FIG. 8 is a flowchart showing a screen reduction method in [Display Method #1];

FIG. 9 is a flowchart showing [Display Method #2] according to Embodiment 1;

FIG. 10 is a drawing for explaining [Display Method #2] according to Embodiment 1;

FIG. 11 is a flowchart showing [Display Method #3] according to Embodiment 1;

FIG. 12A is a drawing for explaining [Display Method #3] according to Embodiment 1;

FIG. 12B is a drawing for explaining [Display Method #3] according to Embodiment 1;

FIG. 12C is a drawing for explaining [Display Method #3] according to Embodiment 1;

FIG. 12D is a drawing for explaining [Display Method #3] according to Embodiment 1;

FIG. 13 is a drawing showing display timing in [Display Method #3] according to Embodiment 1;

FIG. 14 is a block diagram showing the configuration of a display apparatus according to Embodiment 2 of the present invention;

FIG. 15 is a drawing showing the table configuration of a content information storage section according to Embodiment 2;

FIG. 16 is a drawing showing the table configuration of a display control rule storage section according to Embodiment 2;

FIG. 17 is a block diagram showing the configuration of a display apparatus according to Embodiment 3 of the present invention;

FIG. 18 is a flowchart showing the operation of a display control section according to Embodiment 3;

FIG. 19 is a drawing for explaining the operation of a display control section according to Embodiment 3;

FIG. 20 is a drawing for explaining [Display Method #4] according to Embodiment 3; and

FIG. 21 is a drawing for explaining [Display Method #4] according to Embodiment 3.

### DESCRIPTION OF EMBODIMENTS

Now, embodiments of the present invention will be described in detail with reference to the accompanying drawings.

### Embodiment 1

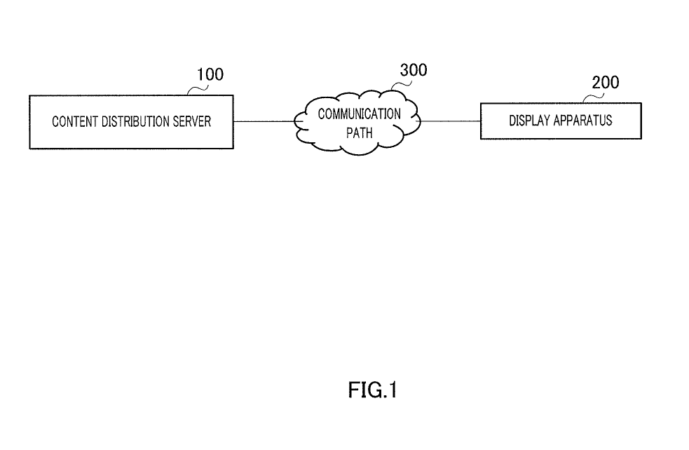

FIG. 1 is a drawing showing the overall schematic configuration of an information display system according to an embodiment of the present invention.

The information display system in FIG. 1 is a system in which a plurality of content items are played back by display apparatus 200, and includes content distribution server 100 that performs holding and distribution of content, display apparatus 200 that acquires and plays back a plurality of content items and performs overlapping display of a plurality of content items, and communication path 300 mutually connecting content distribution server 100 and display apparatus 200.

Content distribution server 100 is a server apparatus or broadcasting station facility that has a function for connecting to communication path 300, holds content and content information, and transmits content and content information to display apparatus 200. Here, content information is information used by a user to identify content. Content information will be described later herein. Content distribution server 100 is implemented by means of a workstation or the like.

Display apparatus 200 is an apparatus that has a function for connecting to communication path 300, acquires and holds content or content information from content distribution server 100, outputs content or content information to a display section (screen) of a display or the like, and performs content playback and information display.

Specifically, display apparatus 200 is a data playback apparatus, data recording apparatus, or a device combining these, such as an STB (Set Top Box), digital TV (Television), DVD (Digital Versatile Disc) recorder, HDD (Hard Disk Drive) recorder, PC (Personal Computer), PDA (Personal Digital Assistant), mobile phone, or the like, for receiving digital broadcasting.

Communication path 300 is a network that connects content distribution server 100 and display apparatus 200 unidirectionally or bidirectionally. Specifically, communication path 300 comprises a broadcast signal from a broadcasting station, a wired network such as Ethernet (registered trademark), a radio network such as a radio LAN (Local Area Network), or a network combining these.

The configurations of content distribution server 100 and display apparatus 200 will now be described in detail.

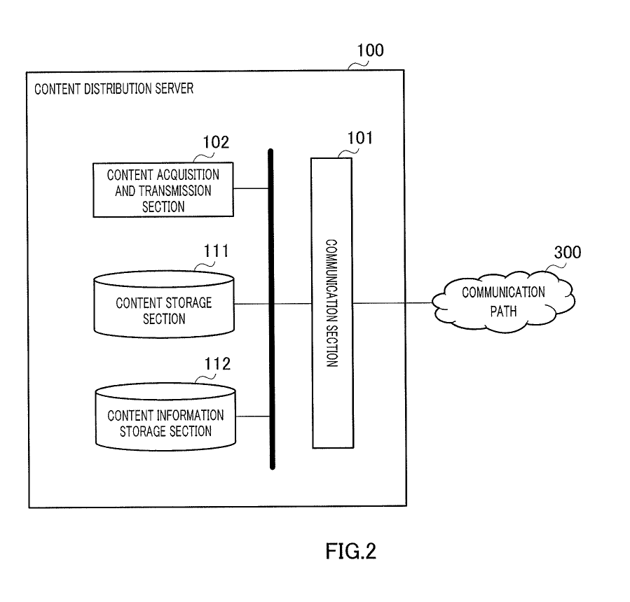

First, the configuration of content distribution server 100 will be described in detail. FIG. 2 is a block diagram showing the detailed configuration of content distribution server 100.

Content storage section 111 stores content such as a news program, sports program, music program, video, stage play, drama, variety, documentary, or the like.

Content information storage section 112 stores content information as identification information for identifying content. In this embodiment, an example will be described in which content information storage section 112 stores a content title as content information.

Communication section 101 connects to communication path 300, and communicates with display apparatus 200.

Content acquisition and transmission section 102 acquires content from content storage section 111, acquires content information from content information storage section 112, and transmits the acquired content and content information to display apparatus 200.

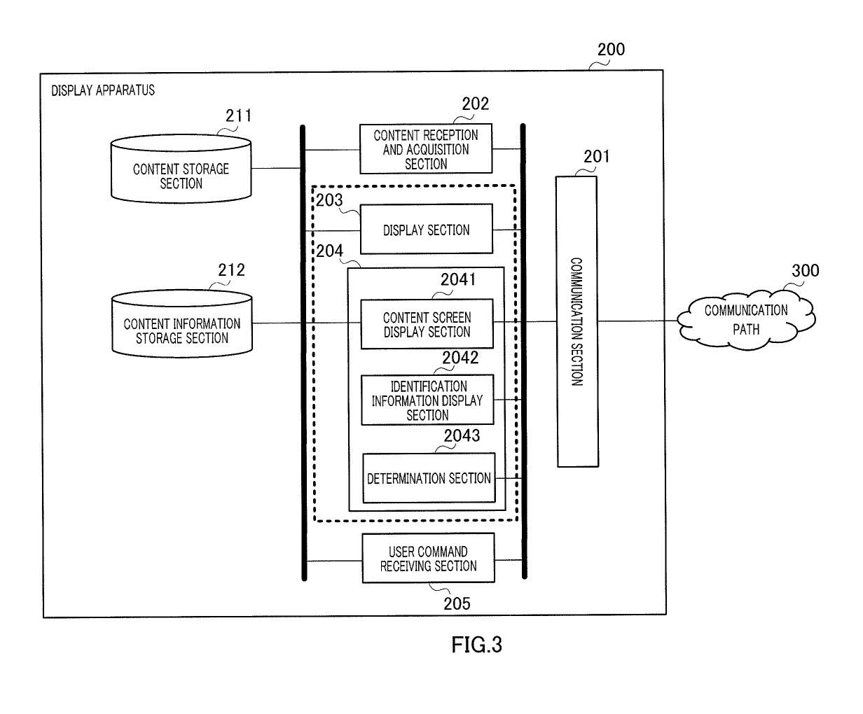

Next, the configuration of display apparatus 200 will be described in detail. FIG. 3 is a block diagram showing the detailed configuration of display apparatus 200. Communication section 201 connects to communication path 300, and communicates with content distribution server 100 and other terminal apparatuses.

Content reception and acquisition section 202 receives and acquires content or content information transmitted from content distribution server 100.

Content storage section 211 stores content received and acquired by content reception and acquisition section 202.

Content information storage section 212 stores content information received and acquired by content reception and acquisition section 202.

Display section 203 is a display device such as a plasma display panel or liquid crystal panel (not shown) that displays a content screen or content information.

Display control section 204 includes content screen display section 2041, identification information display section 2042, and determination section 2043.

Content screen display section 2041 controls the display position and display size of content screens of a plurality of content items for which a content acquisition request has been input to display apparatus 200 via user command receiving section 205. Specifically, content screen display section 2041 controls the display position and display size in an overall screen area for a plurality of content screens that display respective content items so that each content display screen includes an occupied area that does not overlap another content screen. Here, content screen display section 2041 generates and outputs display data for performing superimposed display of a plurality of content screens upon an area larger than an occupied area based on a determination result of determination section 2043 described later herein. The display position, display size, and display format of a content screen will be described later herein.

Identification information display section 2042 controls the display position and display format of content information, and displays content information on display section 203. The display position and display format of content information will be described later herein.

Determination section 2043 determines whether or not one content screen displayed in a predetermined occupied area from among a plurality of occupied areas has been identified by a user. There are no particular restrictions on the determination method, and, for example, provision may be made for determination section 2043 to use a timer to determine that a user has identified a content screen displayed in an occupied area when a predetermined time has elapsed since display control section 204 displayed the content screen in the occupied area. Alternatively, provision may be made for a user to input a command indicating content identification completion to user command receiving section 205 when a user identifies a desired content screen. Then, provision may be made for determination section 2043 to determine that a user has identified a content screen displayed in an occupied area when a content identification completion result is input via user command receiving section 205. Determination section 2043 outputs a determination result to content screen display section 2041.

User command receiving section 205 receives input from a user by means of a remote control, direct operation of display apparatus 200, or the like. For example, user command receiving section 205 receives input such as a content identifier uniquely identifying content, a content acquisition command, a content identification completion result, and so forth.

Of the storage sections and processing sections composing content distribution server 100 and display apparatus 200, the storage sections are implemented by means of storage media such as an HDD or RAM (Random Access Memory), and the processing sections are implemented by means of programs or the like executed using LSI (Large Scale Integration) or suchlike hardware or a CPU (Central Processing Unit), RAM, ROM (Read Only Memory), or the like. It is desirable for the storage sections and processing sections in display apparatus 200 to be made tamper-resistant by means of hardware or software.

Next, data and data structures handled in this embodiment will be described.

Content storage section 111 of content distribution server 100 is a database that manages content, and is used to acquire content corresponding to a content identifier included in a content distribution schedule or a content acquisition request from display apparatus 200. Here, a content distribution schedule is a schedule of content distributed from content distribution server 100, and a content identifier is information for uniquely identifying content in the information display system.

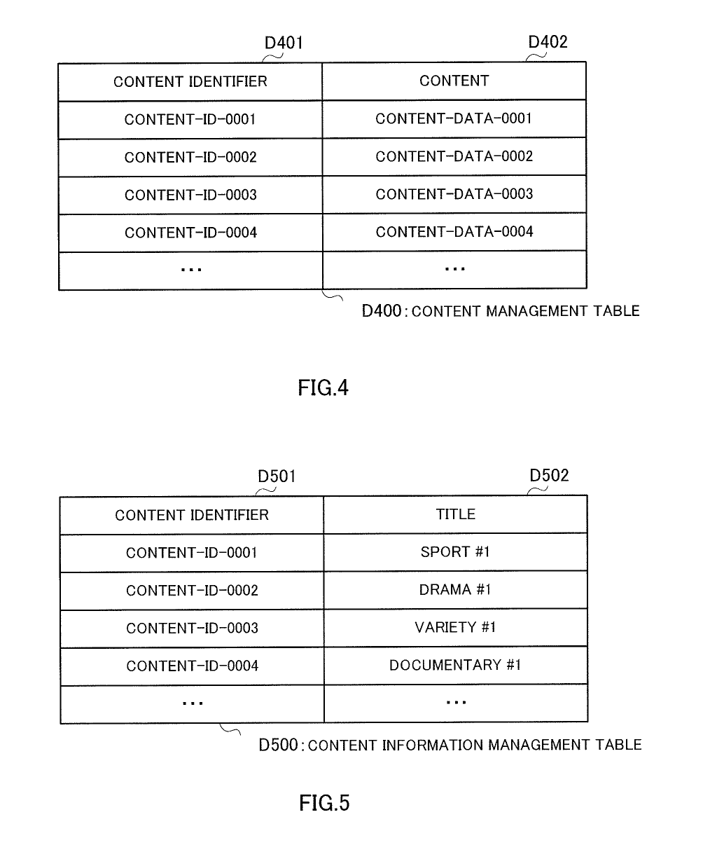

Specifically, as shown in FIG. 4, content storage section 111 has content management table D400 comprising content identifier D401 and content D402 corresponding to content identifier D401. For example, FIG. 4 shows that content D402 having “CONTENT-ID-0001” as content identifier D401 is “CONTENT-DATA-0001.” Registration of content and content identifiers in content storage section 111 is performed by a content provider or the like.

Content storage section 211 of display apparatus 200 is a database that manages content, and stores content acquired from content storage section 111 associated with a content identifier in the same way as content storage section 111 of content distribution server 100.

Data registration in content storage section 211 is performed by content reception and acquisition section 202 when a content acquisition request is input to display apparatus 200 via user command receiving section 205.

Content information storage section 112 of content distribution server 100 is a database that manages content information, and is used to acquire content information corresponding to a content identifier included in a content acquisition request from display apparatus 200. Content information is identification information for identifying content, and is used as determination material when a user himself determines whether or not content is desired content.

For example, as shown in FIG. 5, content information storage section 112 has content information management table D500 in which content identifier D501, and content title D502 as content information, are mutually associated. FIG. 5 shows that when content identifier D501 is “CONTENT-ID-0001,” content title D502 is “Sport #1.” Registration of content information in content information storage section 112 is performed by a content provider or the like.

Content information storage section 212 of display apparatus 200 is a database that manages content information, and stores content information acquired from content information storage section 112 associated with a content identifier in the same way as content information storage section 112.

Data registration in content information storage section 212 is performed by content reception and acquisition section 202 when a content acquisition request is input to display apparatus 200 via user command receiving section 205.

Next, processing of each section in an information display system will be described up until display apparatus 200 receives a plurality of content items and displays a plurality of content screens so as to be viewable by each user while suppressing a sacrifice of screen size.

(1) Content Reception and Acquisition Processing

Content reception and acquisition section 202 starts content acquisition processing in response to information input from a user and a content acquisition command A user inputs a content identifier or information based on a content identifier to a display apparatus 200 application via user command receiving section 205. A case is described below in which content identifier “CONTENT-ID-0001” is specified by a user searching by content title, selecting content from an EPG (Electronic Program Guide) screen, or the like, and content reception and acquisition section 202 starts content acquisition processing.

When user command receiving section 205 receives input from a user, content reception and acquisition section 202 generates a content acquisition request message including a content identifier, and transmits the generated content acquisition request message to content distribution server 100 via communication section 201.

Content distribution server 100 receives the content acquisition request message via communication section 101. Next, content acquisition and transmission section 102 extracts content identifier “CONTENT-ID-0001” from the content acquisition request message, and acquires corresponding “CONTENT-DATA-0001,” and content title “Sport #1” as content information, from content storage section 111 and content information storage section 112.

Then content acquisition and transmission section 102 generates a content transmission message including the acquired content and content title, and transmits the generated content transmission message to display apparatus 200 via communication section 101.

On receiving the content transmission message via communication section 201, content reception and acquisition section 202 of display apparatus 200 stores the received content in content storage section 211. Also, content reception and acquisition section 202 performs data registration of the content title in content information storage section 212.

Here, a case in which content distribution server 100 performs on-demand distribution (individual distribution) via the Internet has been described as an example of content acquisition, but the content and content information distribution method is not limited to this, and download distribution, multicast distribution, broadcast distribution, and so forth, may also be used. In broadcast distribution, content switching involves a change of processing on the terminal side rather than a change of processing on the server side. Consequently, when content viewed by a user is switched, the above processing is performed for each content item after switching.

In the above-described way, content reception and acquisition section 202 acquires content and a content title as content information from content distribution server 100 by means of a content acquisition command from a user. A configuration is also possible whereby a content title is stored beforehand in content information storage section 112 included in a user terminal, and is acquired according to a user request.

(2) Display Processing

Next, processing of each section will be described up until display control section 204 of display apparatus 200 is able to display a plurality of content screens so as to be viewable by each user while suppressing a sacrifice of screen size.

[Display Method #1]

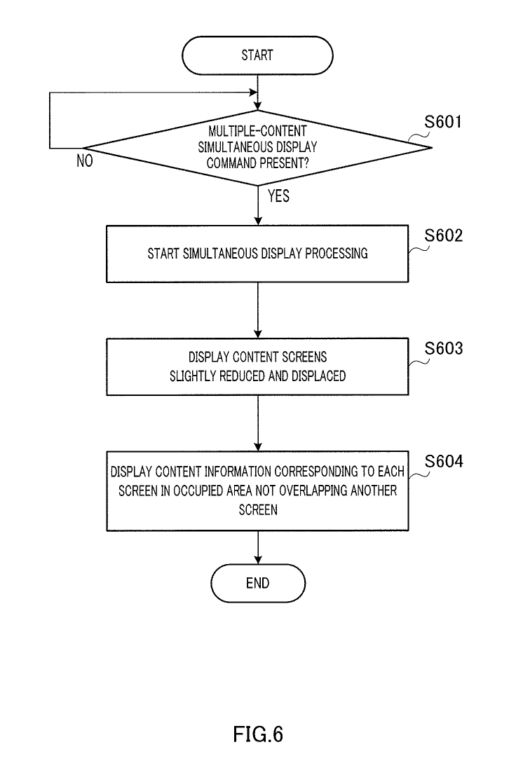

FIG. 6 is a flowchart showing [Display Method #1] according to this embodiment.

Content screen display section 2041 determines the presence or absence of a multiple-content simultaneous display command (step S601). Content screen display section 2041 determines the presence or absence of a multiple-content simultaneous display command based on a default setting or user setting. As a default setting example, content screen display section 2041 determines that there is a multiple-content simultaneous display command if, for example, a simultaneous display command for a plurality of content screens is input via user command receiving section 205 by means of a user remote operation or the like. Specifically, content screen display section 2041 determines that there is a simultaneous display command for a plurality of content screens if user command receiving section 205 receives another content display command, a zapping command, or the like, during display of a particular content screen.

In the event of determining that there is a multiple-content simultaneous display command, content screen display section 2041 starts simultaneous display processing (step S602).

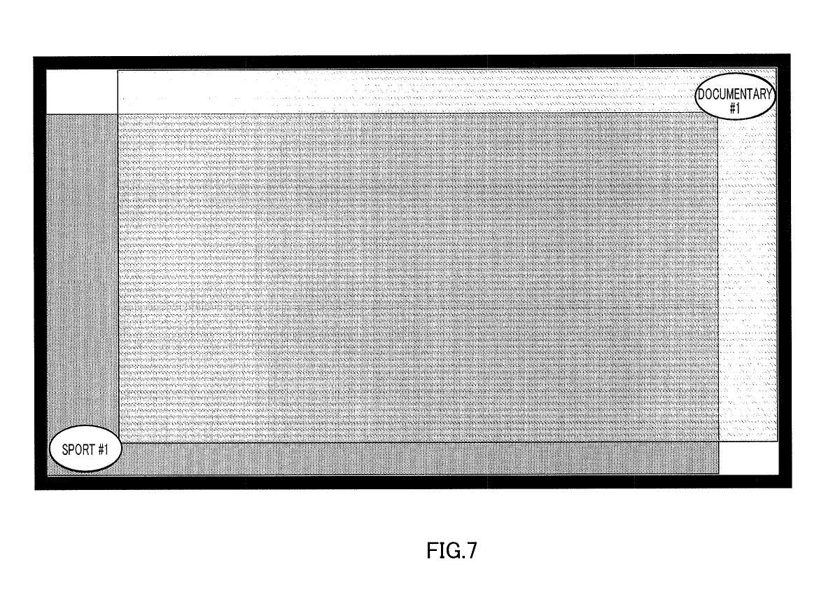

Display processing will be described below using FIG. 7, taking a case in which there is a command to display two content items as an example. FIG. 7 is an example of a case in which a simultaneous display command is received for content identifier “CONTENT-ID-0001” of title “Sport #1” and content identifier “CONTENT-ID-0004” of title “Documentary #1” shown in FIG. 5 as the two content items.

First, content screen display section 2041 reduces the two content screens to a screen size smaller than the full screen size of display section 203, and displaces part of the two content screens (step S603). In the example shown in FIG. 7, the content identifier “CONTENT-ID-0001” (titled “Sport #1”) content screen is aligned with the bottom-left of the display section 203 screen area, and the content identifier “CONTENT-ID-0004” (titled “Documentary #1”) content screen is aligned with the top-right of the display section 203 screen area.

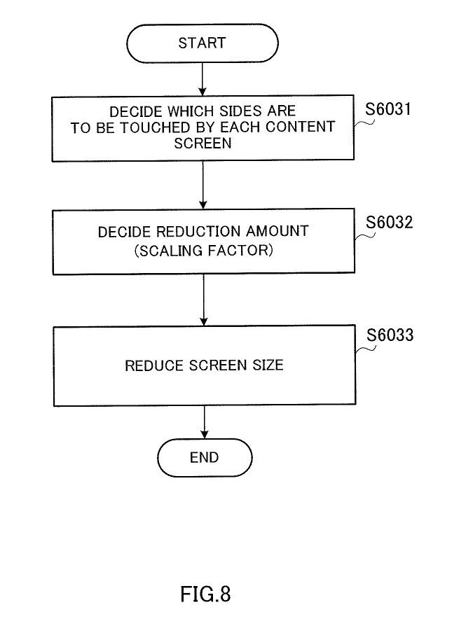

The operation to reduce the screen sizes in content screen display section 2041 (step S603) will now be described in detail using FIG. 8.

First, content screen display section 2041 decides which of the four sides of the full screen of display section 203 are to be touched by each content screen in accordance with a predetermined rule (step S6031). For example, content screen display section 2041 may cause the content image displayed first on display section 203 to touch the left side. Alternatively, content screen display section 2041 may decide sides to be touched by each content screen based on a user's position with respect to display section 203, as explained in Embodiment 2 described later herein.

Provision may also be made for content screen display section 2041 to decide a number of sides among the four sides of the full screen of display section 203 that are to be touched by each content screen according to a number of content screens simultaneously displayed on display section 203. Examples of deciding the number of sides according to the number of content screens are shown below.

When the number of content screens is 2: Two adjacent sides (two sides including the top and right or bottom and left) are decided upon.

When the number of content screens is 3 or 4: One side is decided upon.

When the number of content screens is 5 or more: Two or more content screens are assigned to one side.

Next, content screen display section 2041 decides a reduction amount (scaling factor) of each content screen (step S6032). Content screen display section 2041 uses a predetermined value as a reduction amount (scaling factor), or decides a reduction amount (scaling factor) based on identification information to be displayed.

Then content screen display section 2041 fixes a point on a side to be touched by a content screen decided in S6031, and reduces the screen size (step S6033).

Content screen display section 2041 performs screen size reduction as shown below, for example, according to the number of content screens simultaneously displayed on display section 203.

When the number of content screens is 2: A point on a side touched by a content screen is fixed, and the screen size is reduced.

When the number of content screens is 3 or 4: The center point of a side touched by a content screen is fixed, and the screen size is reduced.

When the number of content screens is 5 or more: Two points moved horizontally (or vertically) by the reduction amount from the center point of a side to which two screens are assigned are fixed, and each screen size is reduced.

Thus, a rule for setting a fixed point may be changed based on information on the display screen area of display section 203 and information on the number of content screens displayed simultaneously.

The example shown in FIG. 7 is an example in which content screen display section 2041 controls the positions of a plurality of content screens so that an overlapping area in the screen area of display section 203 is as small as possible. As a method of arranging two superimposed content screens so that an overlapping area is as small as possible, when the display screen area of display section 203 is rectangular, for example, arrangement can be performed so that two vertices included in a diagonal line are a vertex and fixed point of the respective content screens. Also, if the display screen area of display section 203 is large, arrangement may be performed so that two vertices included in a long side rather than a diagonal line are a vertex and fixed point of the respective content screens.

In this way, content screen display section 2041 controls the positions of a plurality of content screens, and performs transparent display of two content screens at the controlled content screen positions.

Identification information display section 2042 displays respective content information in a screen area (occupied area) in which the two content screens are not superimposed (step S604). In the example shown in FIG. 7, the title of each content item is displayed as content information. Specifically, for content identifier “CONTENT-ID-0001,” identification information display section 2042 displays title “Sport #1” in the bottom-left area of the display section 203 screen. The bottom-left area of the display section 203 screen is an area occupied by and displaying only content identifier “CONTENT-ID-0001” content. Also, for content identifier “CONTENT-ID-0004,” identification information display section 2042 displays content title “Documentary #1” in the top-right area of the display section 203 screen. The top-right area of the display section 203 screen is an area occupied by and displaying only content identifier “CONTENT-ID-0004” content.

In the above-described way, content screen display section 2041 performs reduction to a screen size smaller than the full screen size of display section 203, and performs transparent display of a plurality of content screens while providing each of the plurality of content screens with an occupied area that does not overlap another content screen. Then identification information display section 2042 displays content information in an occupied area in which another content screen is not displayed in a superimposed fashion. In this way, a content title for identifying respective content items s displayed in an occupied area in which another content screen is not displayed in a superimposed fashion, enabling each user to identify content displayed in an occupied area in which a title is displayed. Determination section 2043 determines whether or not a user has identified a content screen displayed in an occupied area by means of a user instruction from the user or the like, and outputs the determination result to content screen display section 2041.

Then, when it is confirmed by determination section 2043 that each user's awareness is directed toward a desired content screen, content screen display section 2041 performs transparent display of the plurality of content screens, and performs superimposed display of most of those content screens. At this time, each user can determine and view desired content from a superimposed screen area by directing his awareness toward occupied area identification information, and enlarging the field of view to the entire screen from there. By this means, each user can simultaneously view individual desired content while suppressing a sacrifice of screen size.

Also, by performing the kind of processing described above when content screen switching is performed, display apparatus 200 can also display content that each user wishes to view among a plurality of content items when a user performs channel zapping or the like in a simultaneously viewable fashion while suppressing a sacrifice of screen size.

Provision may also be made for identification information display section 2042 to display content information for only a predetermined period. Furthermore, provision may also be made for identification information display section 2042 not to display content information when it is confirmed by determination section 2043 that the awareness of a user is not directed toward a desired content screen.

In this embodiment, identification information display section 2042 displays content information in order to direct each user's awareness toward a desired content screen. Therefore, once a user's awareness has been able to be directed toward a desired content screen, content information becomes unnecessary for viewing content.

Consequently, providing for content information not to be displayed after a user's awareness has been directed toward a desired content screen means that only necessary content is displayed in an occupied area, enabling each user to view desired content more easily.

In the above-described way, content screen display section 2041 performs transparent display of a plurality of content screens on display section 203 while adjusting the display positions of the plurality of content screens on display section 203 and providing each of the plurality of content screens with an occupied area that does not overlap another content screen. By this means, the awareness of each user can be directed from content information displayed in an occupied area toward a desired content screen the user wishes to view, and each user's desired content can be displayed in a simultaneously viewable fashion while suppressing a sacrifice of screen size. Furthermore, by displaying content information in an occupied area that enables identification of a content screen in that occupied area, identification information display section 2042 can shorten the time required for a user's awareness to be directed toward desired content.

In the above description, a user's awareness is directed toward desired content by displaying content information, but provision may also be made for a desired content screen to be determined from a plurality of content screens by highlighting a fixed point at the time of content screen reduction, and prompting a user to perform enlargement from that fixed point to the entire screen (for example, to enlarge the field of view from a top-right fixed point toward the bottom-left).

[Display Method #2]

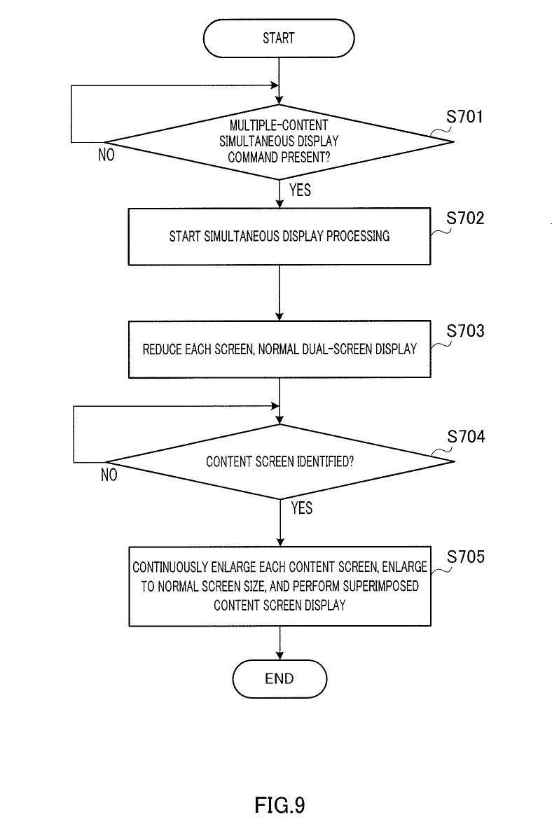

FIG. 9 is a flowchart showing [Display Method #2] according to this embodiment.

In the same way as in steps S601 and S602, content screen display section 2041 starts display processing by means of a multiple-content simultaneous display command from a user (steps S701 and S702).

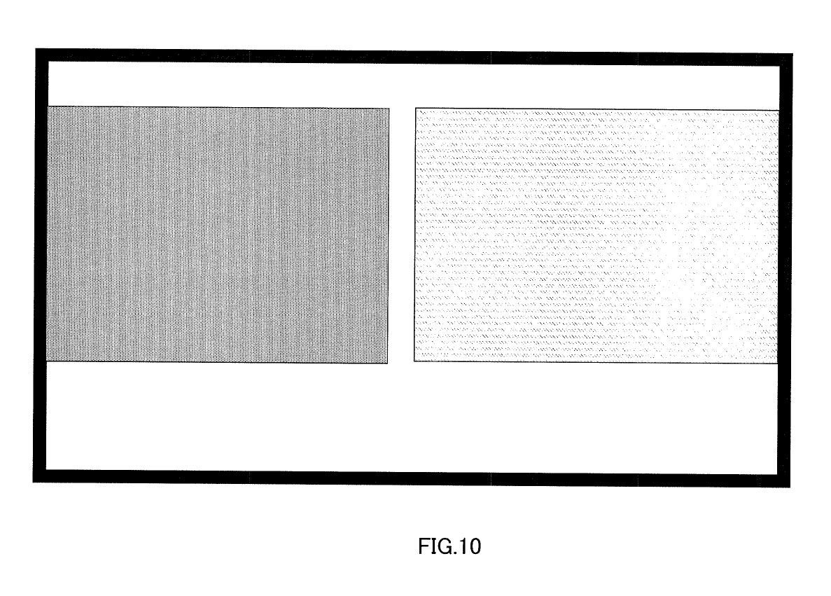

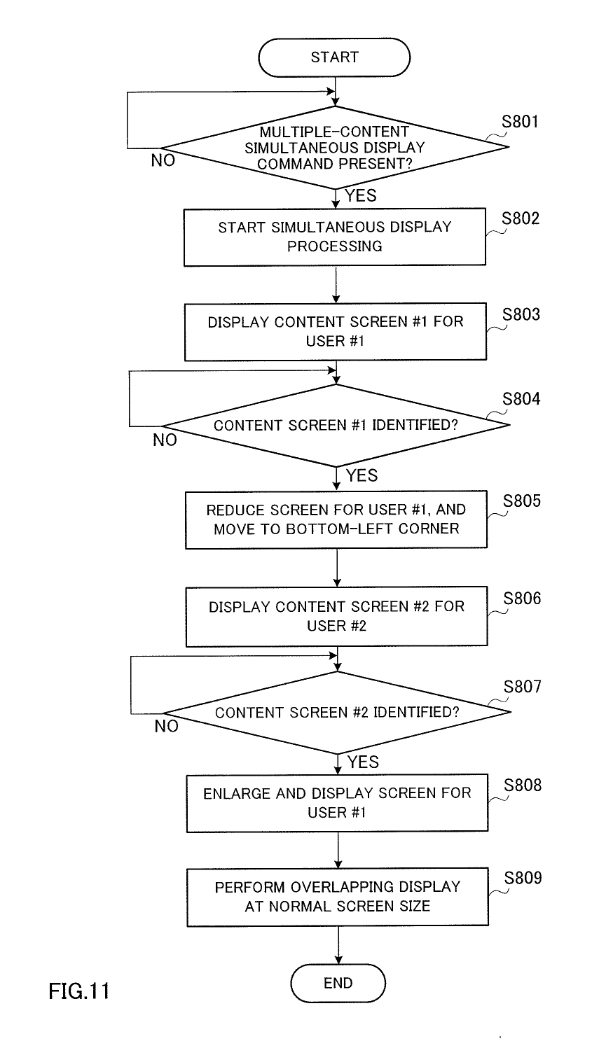

Display processing will be described below using FIG. 10, taking a case in which there is a command to display two content items as an example. FIG. 10 is an example of a case in which a simultaneous display command is received for content identifier “CONTENT-ID-0001” of title “Sport #1” and content identifier “CONTENT-ID-0004” of title “Documentary #1” shown in FIG. 5 as the two content items.

First, content screen display section 2041 reduces the two content screens to a small screen size not more than half the full screen size of display section 203, and performs dual-screen display on display section 203. In the example shown in FIG. 10, content identifier “CONTENT-ID-0001” (titled “Sport #1”) content is positioned on the left side of the display section 203 screen, and content identifier “CONTENT-ID-0004” (titled “Documentary #1”) content screen is positioned on the right side of the display section 203 screen.

Then content screen display section 2041 performs transparent display of the two content screens. Specifically, as shown in FIG. 10, the screen area of display section 203 is divided into two, and dual-screen display is performed in a state in which the content screens do not overlap (step S703). By this means, each user's awareness can be directed toward a desired content screen.

Then determination section 2043 determines whether or not a user has identified a content screen displayed in an occupied area by means of a user instruction from the user or the like (step S704).

Then at a stage at which each user's awareness is directed toward a desired content screen, content screen display section 2041 gradually and continuously enlarges the area of each content screen, and performs superimposed content screen display (step S705). A finally enlarged screen area may be of the full screen size of display section 203, or, as shown in FIG. 7, there may be occupied areas without superimposition in only the bottom-left corner and top-right corner of display section 203.

At this time, as content screen display section 2041 gradually and continuously enlarges the area of each content screen, each user's viewpoint moves in accordance with the content screen size. Consequently, when each user's awareness is directed toward a desired content screen by means of step S703, each user can view desired content without content information being displayed.

In the above-described way, content screen display section 2041 enables each user's awareness to be directed toward a relevant content screen by displaying a plurality of content screens on display section 203 without superimposition. Then, when determination section 2043 determines that each user's awareness is directed toward a desired content screen, content screen display section 2041 gradually enlarges the size of each content screen, and performs transparent display of the plurality of content screens in a superimposed fashion. Performing transparent display of a plurality of content screens in a superimposed fashion after directing each user's awareness toward a desired content screen in this way enables each user to extract and view desired content from a superimposed screen area. By this means, users can view simultaneously while a sacrifice of screen size is suppressed.

[Display Method #3]

FIG. 11 is a flowchart showing [Display Method #3] according to this embodiment.

In the same way as in steps S601 and S602, content screen display section 2041 starts simultaneous display processing by means of a multiple-content simultaneous display command from a user (steps S801 and S802).

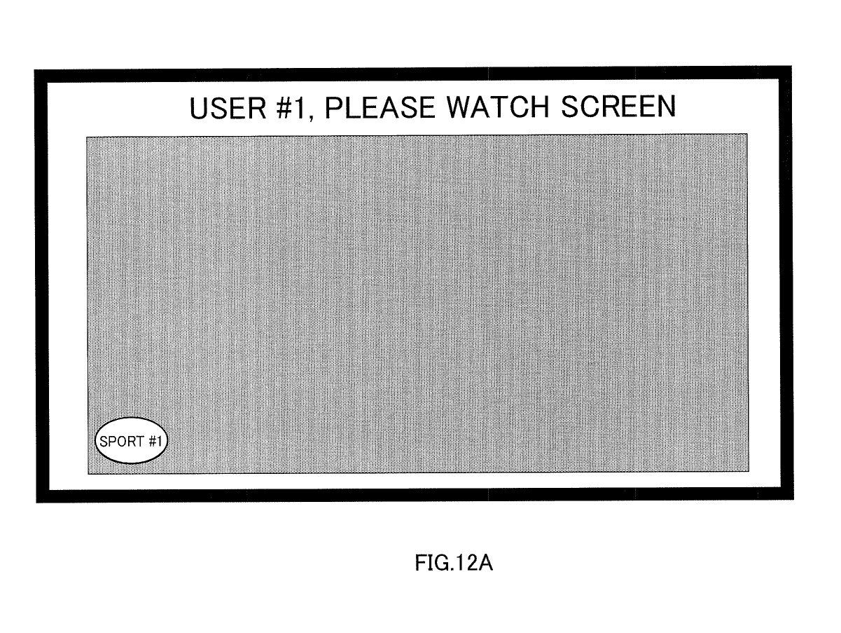

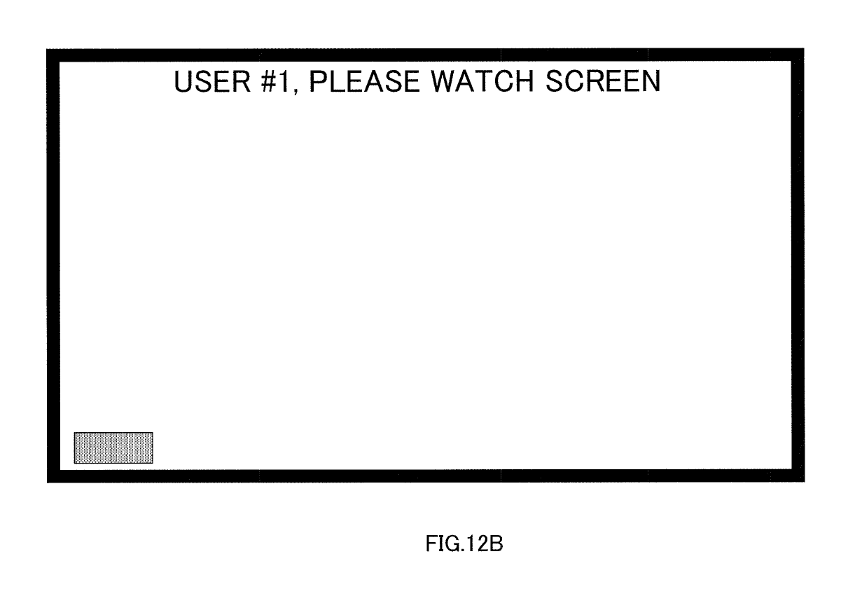

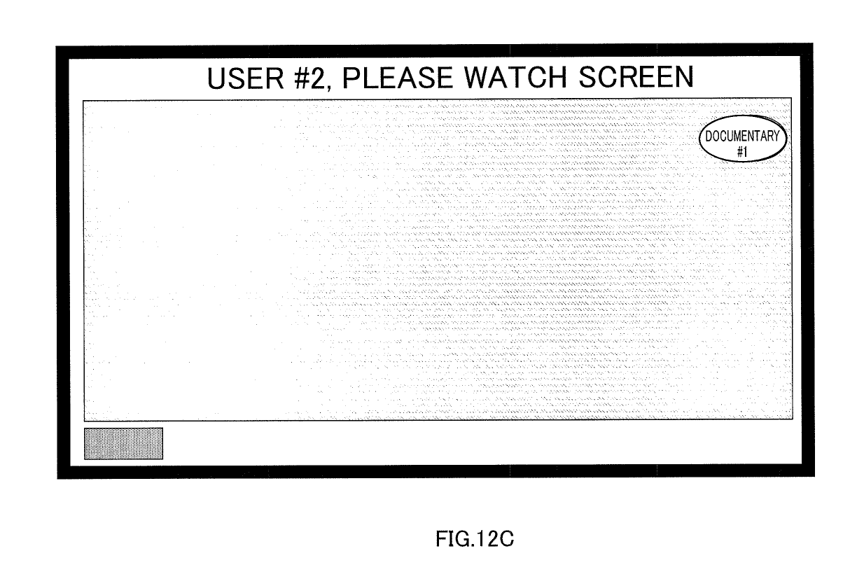

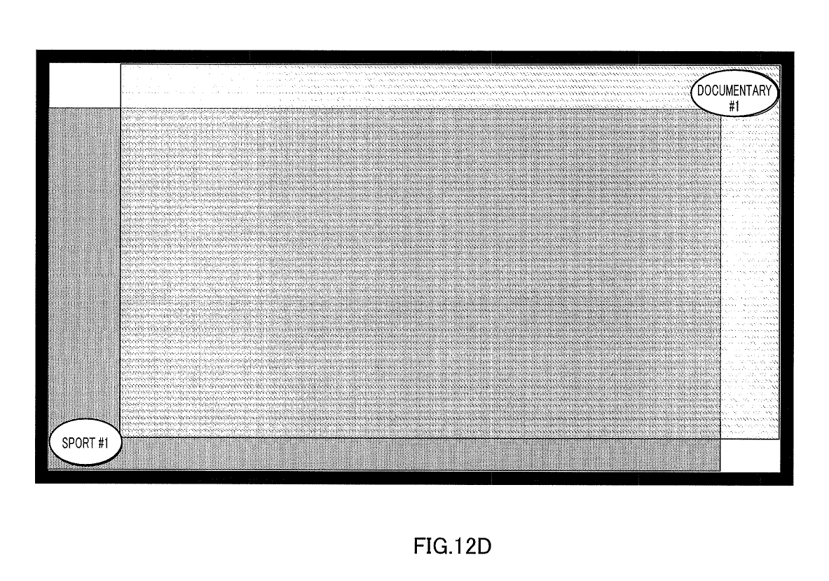

Display processing will be described below using FIG. 12A, FIG. 12B, FIG. 12C, and FIG. 12D, taking a case in which there is a command to display two content items as an example. FIG. 12A, FIG. 12B, FIG. 12C, and FIG. 12D are examples of a case in which a simultaneous display command is received for content identifier “CONTENT-ID-0001” of title “Sport #1” and content identifier “CONTENT-ID-0004” of title “Documentary #1” shown in FIG. 5 as the two content items.

First, at predetermined display timing (hereinafter referred to as “display timing #1”), content screen display section 2041 performs large screen size display in the center of display section 203 of a content screen of user #1's desired content identifier “CONTENT-ID-0001” content screen (hereinafter referred to as “content screen #1”) (step S803). Provision may also be made for “User #1, please watch screen” to be displayed at the top of the content screen, and for content identifier “CONTENT-ID-0001” content title “Sport #1” also to be displayed, as shown in FIG. 12A.

Determination section 2043 determines whether or not user #1's awareness is directed toward desired content screen #1 via user command receiving section 205 by means of a remote operation from user #1 or the like (step S804). Then, when determination section 2043 confirms that user #1+s awareness is directed toward desired content screen #1, content screen display section 2041 displays content screen #1 at display timing #1 while gradually reducing the screen area (step S805). In step S805, FIG. 12B shows how content screen #1 is finally displayed in a small screen size in a corner of display section 203. In this way, once user #1's awareness has been directed toward a large screen, user #1's awareness is maintained while being moved to a small screen in a corner of display section 203.

Next, at predetermined display timing different from display timing #1 (hereinafter referred to as “display timing #2”), content screen display section 2041 performs large screen size display in the center of display section 203 of a content screen of user #2's desired content identifier “CONTENT-ID-0004” content screen (hereinafter referred to as “content screen #2”) (step S806). Provision may also be made for “User #2, please watch screen” to be displayed at the top of the content screen, and for content identifier “CONTENT-ID-0004” content title “Documentary #1” also to be displayed, as shown in FIG. 12C.

Determination section 2043 determines whether or not user #2's awareness is directed toward desired content screen #2 via user command receiving section 205 by means of a remote operation from user #2 or the like (step S807). Then, when determination section 2043 confirms that user #2's awareness is directed toward desired content screen #2, content screen display section 2041 displays content screen #2 at display timing #2, and gradually enlarges the screen area of content screen #1 in the top-right direction while displaying content screen #1 to which user #1's awareness was previously directed at display timing #1 (step S808). Gradually enlarging the small screen in the bottom-left corner in FIG. 12B toward the top-right enables the distance of movement of user #1's line of sight to be kept to a minimum.

After enlarging the screen area of content screen #1, content screen display section 2041 performs overlapping display of content screen #1 and content screen #2 at normal screen size (step S809). The state of display section 203 after enlargement is shown in FIG. 12D.

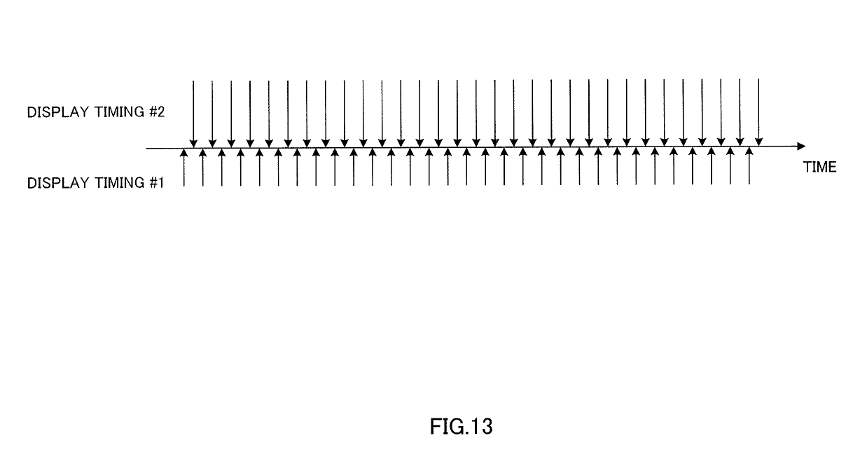

The relationship between display timing #1 and display timing #2 will now be described. FIG. 13 is a drawing showing the relationship between display timing #1 and display timing #2. In step S803, content screen display section 2041 displays content screen #1 in a large screen area in the center of display section 203 at display timing #1 (frame timing group #1) shown in FIG. 13 (see FIG. 12A). At timing other than display timing #1, content screen display section 2041 does not display anything on display section 203.

When it is confirmed by determination section 2043 that user #1's awareness is directed toward content screen #1 by means of a user instruction, content screen display section 2041 gradually reduces the display area of content screen #1 from a large screen area in the center of display section 203, and displays it in a small screen area in the bottom-left corner of display section 203 (see FIG. 12B).

In step S806, content screen display section 2041 displays content screen #2 on display section 203 at display timing #2 (frame timing group #2) shown in FIG. 13 (see FIG. 12C). At display timing #1 timing, content screen display section 2041 continues displaying content screen #1 in a small screen area n the bottom-left corner of display section 203 (see FIG. 12B).

At this time, the rate of display timing #1 and display timing #2 is set to several times the frame rate that can be recognized by a human being, and display is performed using a different frame timing group for the desired content of each user. As a result, once each user's awareness has been able to be directed toward a desired content screen, a user whose awareness is directed toward content screen #1 displayed at display timing #1 recognizes only desired content screen #1 even though undesired content screen #2 is displayed at display timing #2. By controlling the display timing of each content screen even after a user's awareness has been directed toward a desired content screen, a plurality of content items can be viewed simultaneously on display section 203 while suppressing a sacrifice of screen size, as shown in FIG. 12D.

In the above-described way, content screen display section 2041 displays content screen #1, from among a plurality of content screens, on display section 203 at display timing #1. Then, when it is confirmed by determination section 2043 that user #1's awareness is directed toward content screen #1, content screen display section 2041 displays content screen #2 on display section 203 at display timing #2. By setting the rate of display timing #1 and display timing #2 to several times the frame rate that can be recognized by a human being, and performing display using a different frame timing group for the desired content of each user (frame rate method), each user, once having directed his awareness toward a desired content screen, recognizes only the desired content screen even though content screen #1 and content screen #2 are displayed alternately as large screens. By this means, a plurality of content items can be viewed simultaneously on display section 203 while suppressing a sacrifice of screen size.

In the above description, processing of each section until display control section 204 displays a plurality of content screens so that each user can view while suppressing a sacrifice of screen size has been summarized as “(2) Display processing.” However, “(2) Display processing” may be divided into “(2-1) Plural-screen display method” and “(2-2) Method of directing user's awareness toward desired content screen,” and a transparent display method or frame rate method may be used in (2-1), and any of above-described [Display Method #1] through [Display Method #3] may be used in (2-2). In this case, provision may be made for any combination of a (2-1) method and (2-2) method to be used.

### Embodiment 2

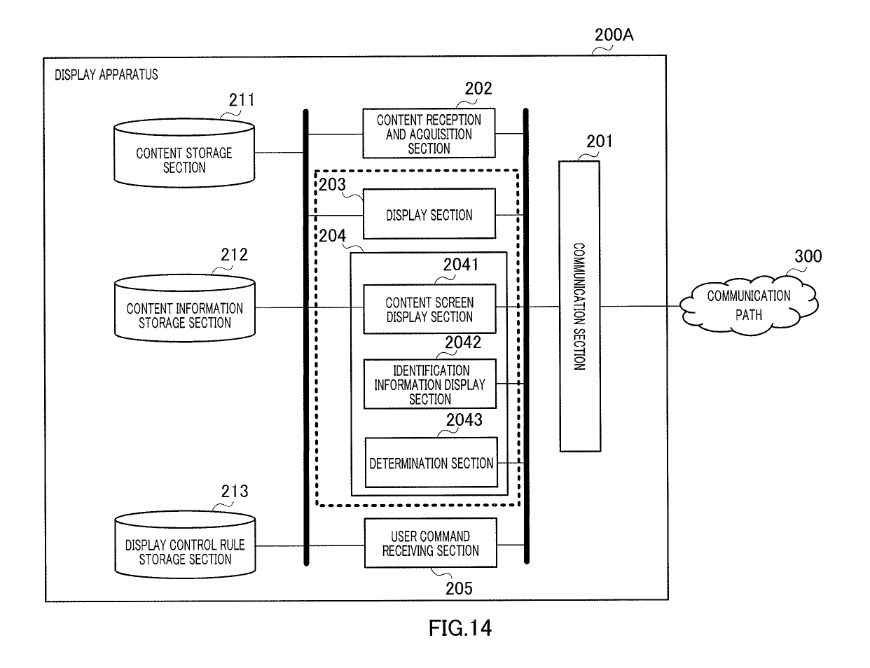

FIG. 14 shows the principal-part configuration of a display apparatus according to this embodiment. In the display apparatus according to this embodiment in FIG. 14, configuration parts common to FIG. 3 are assigned the same reference codes as in FIG. 3, and descriptions thereof are omitted here. Display apparatus 200A in FIG. 14 employs a configuration in which display control rule storage section 213 has been added to display apparatus 200 in FIG. 3.

In this embodiment, content information storage section 212 has content information management table D500 that includes information relating to “Performer,” “Content type,” “Brightness,” “Text display location,” and “Text information size,” in addition to content “Title.”

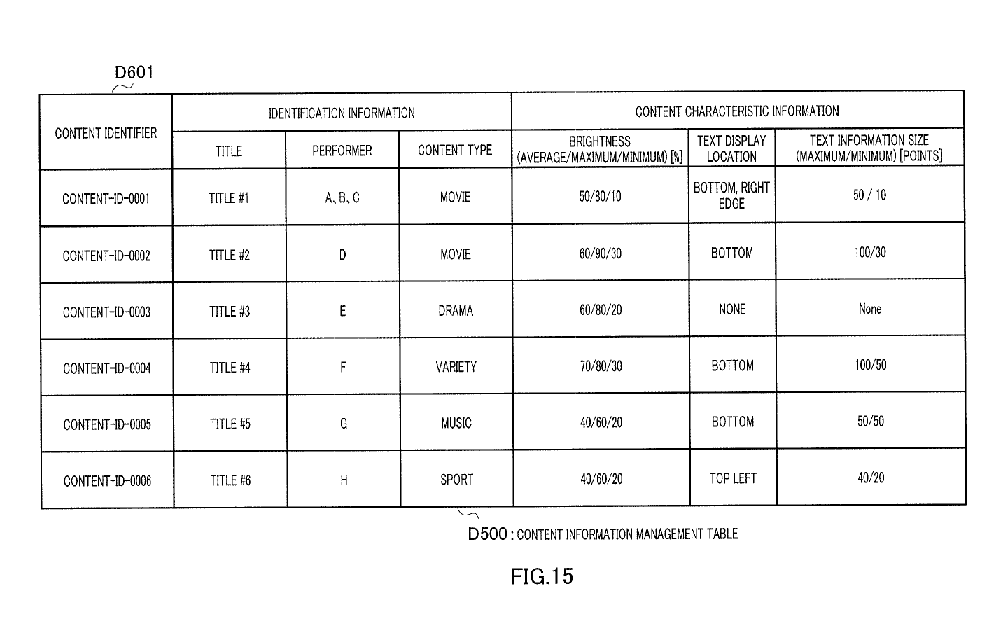

FIG. 15 shows an example of content information management table D500 in this embodiment. In the example shown in FIG. 15, content identifier D601, identification information, and information indicating content characteristics (content characteristic information) are mutually associated in content information management table D500. In the example shown in FIG. 15, “Title,” “Performer,” and “Content type” are associated with a content identifier as identification information, and “Brightness,” “Text display location,” and “Text information size” are associated as content characteristic information. “Content type” indicates a content genre, attribute, or the like, for example.

FIG. 15 shows, for example, that when content identifier D601 is “CONTENT-ID-0001,” the title is “Title #1,” performers are “A, B, C,” and the content type is “Movie,” as identification information, and shows that brightness (average/maximum/minimum [%]) is “50/80/10,” the text display location (maximum/minimum [points]) is “Bottom, right edge,” and the text information size is “50/10,” as content characteristics.

Display control rule storage section 213 is a database that manages display control rules, and is used to set display control rules that control simultaneous display of a plurality of content items according to content characteristic information included in content information management table D500.

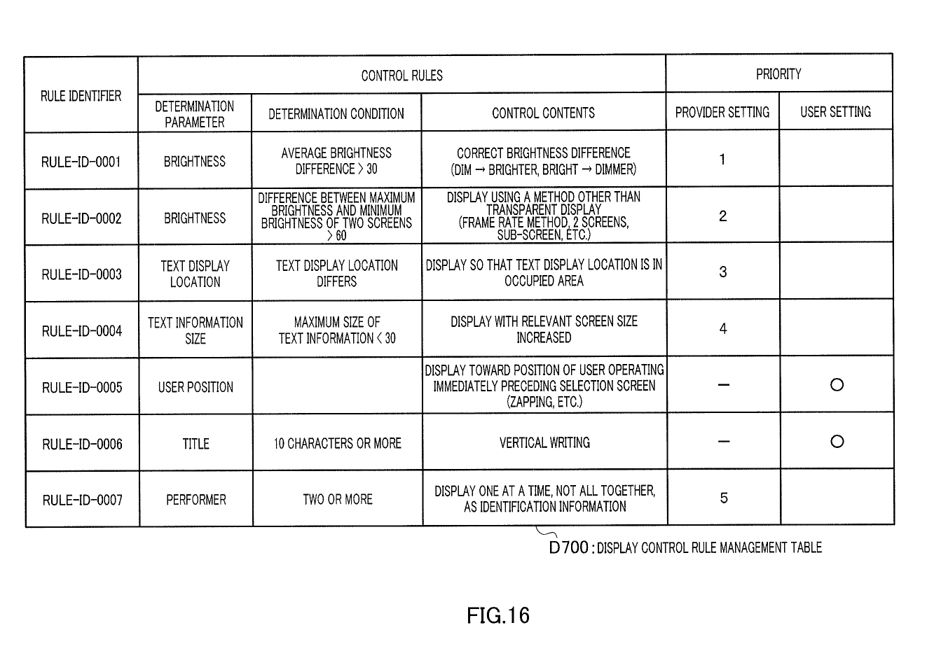

Specifically, as shown in FIG. 16, display control rule storage section 213 has display control rule management table D700 in which a rule identifier, control rules, and priority are mutually associated. In the example shown in FIG. 16, display control rule management table D700 includes a determination parameter, determination condition, and control contents, as control rules, and includes a provider setting and user setting as priority.

For example, in the case of rule identifier “RULE-ID-0001,” when “Brightness” is used as a determination parameter and “Average brightness difference >30,” “Correct brightness difference” applies. By this means, a dim content screen has its brightness increased and is displayed more brightly, and a bright content screen has its brightness decreased and is displayed more dimly, making it possible to prevent an extreme difference in brightness among a plurality of content screens displayed simultaneously. As a result, an undesired content screen can be prevented from being too bright and interfering with viewing of desired content.

Provision may also be made for a bright screen to be displayed in the foreground and a dim screen to be displayed in the background even if “Average brightness difference >30” is not satisfied. By this means, users can easily view their respective desired content items when transparent display of content screens is performed.

Also, provision may be made for color phase, color saturation, or the like, to be changed, or for luminance to be changed by combining these parameters, rather than changing brightness alone.

In the case of rule identifier “RULE-ID-0002,” when “Brightness” is used as a determination parameter and “Difference between maximum brightness and minimum brightness of two screens >60,” “Display using a method other than transparent display” applies. Here, the frame rate display method described in [Display Method #3] of Embodiment 1, the dual-screen display method illustrated in FIG. 10 in [Display Method #2] of Embodiment 1, a sub-screen display method whereby only one content item is displayed in a small screen area, or the like, is used as a “method other than transparent display.” Generally, if superimposed display of a dim content screen and a bright content screen is performed using a transparent display method, it is difficult for users to continuously direct their awareness toward their desired content screens. Thus, when there is a large difference in brightness, preferential use of a method other than a transparent display method enables users to view their desired content more easily.

In the case of rule identifier “RULE-ID-0003,” when text is included in content, if “Text display location” is used as a determination parameter and “Text display location differs,” “Display so that text display location is in occupied area” applies. Here, “occupied area” is an area in which another content screen is not displayed in a superimposed fashion, and providing for text display to be performed in an occupied area makes it possible to prevent text displays of a plurality of content items from being superimposed and being difficult to see.

In the case of rule identifier “RULE-ID-0004,” when text is included in content, if “Text display size” is used as a determination parameter and “Maximum size of text information <30,” “Increase relevant screen size” applies. If the text size is small and small characters are included, securing a larger screen size for displaying content enables text to be displayed in a larger size that is more easily viewed by a user.

In the case of rule identifier “RULE-ID-0005,” a case in which remote control input is received is envisaged, and “User position” is used as a determination parameter. User command receiving section 205 acquires “User position” by detection from the direction of arrival of an operation input signal from a remote control, and “Display(s) relevant content toward the position of the user who used a remote control operation for the immediately preceding content selection command.” A content selection command is a zapping command or the like, for example. By this means, a desired content screen of a user positioned on the left is displayed on the left side of display section 203, and a desired content screen of a user positioned on the right is displayed on the right side of display section 203, enabling users to view their respective content items in a natural posture.

In the case of rule identifier “RULE-ID-0006,” when a content “Title” is used as a determination parameter and the content title is “10 characters or more,” the title is displayed in “Vertical writing.” As explained above, a title is used as determination material when a user himself determines whether or not content is desired content.

Therefore, it is desirable for a title to be integrated with a content screen as far as possible, and for titles to be displayed as far away from each other as possible. Since the screen area of display section 203 is normally wider than it is high, it is desirable for titles to be arranged separated in the horizontal direction of the display section 203 screen area.

However, if a title containing a large number of characters is displayed in horizontal writing, the title display may extend beyond the center of the screen area, making it difficult to determine at a glance which content screen the title corresponds to. Thus, if a title contains a large number of characters, displaying the title in vertical writing enables a plurality of titles to be arranged separated in the horizontal direction of the display section 203 screen area, making it easier for a user to identify a desired content screen based on its title.

In the case of rule identifier “RULE-ID-0007,” when the number of performers is “Two or more,” the performers are not displayed all together as content information, but sequentially one at a time. By this means, the content information display area can be kept small, and can be prevented from interfering with viewing of desired content.

In this way, display control rule storage section 213 manages display control rules. Data registration or updating in display control rule storage section 213 is performed by pre-registration before display apparatus 200 is shipped, or reception via communication section 201 from a provider device, another terminal, or the like. Since display control rule registration or updating can be performed via communication section 201, flexible display control by a provider, terminal manufacturer, or the like, is possible.

As shown in FIG. 16, a priority is set for each rule identifier by the provider, and if conditions conflict, control can be performed according to priority.

In the above description, display control rules have been described as being set from a provider's viewpoint, but provision may also be made for settings to be made from a user's viewpoint so as to provide good visibility for the user himself. In this case, a provider may provide a user with items for which setting is permitted and items for which setting is not permitted. Also, the priority of a display control rule set by a user may be made higher than a priority set by a provider.

### Embodiment 3

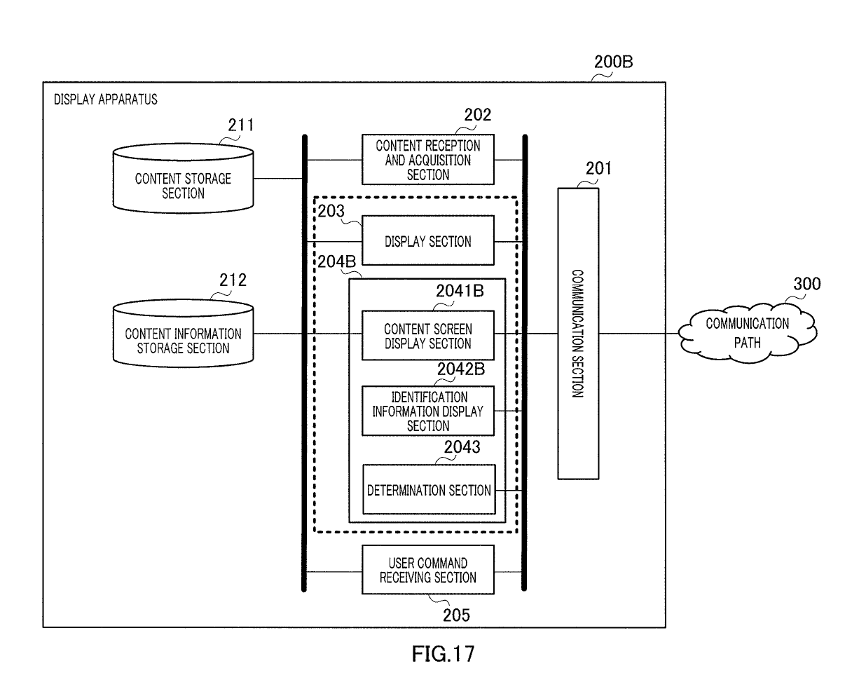

FIG. 17 shows the principal-part configuration of a display apparatus according to this embodiment. In the display apparatus according to this embodiment in FIG. 17, configuration parts common to FIG. 3 are assigned the same reference codes as in FIG. 3, and descriptions thereof are omitted here. Display apparatus 200B in FIG. 17 has display control section 204B instead of display control section 204 of display apparatus 200 in FIG. 3.

Display control section 204B includes content screen display section 2041B, identification information display section 2042B, and determination section 2043.

In the same way as content screen display section 2041, content screen display section 2041B controls the display position and display size of content screens of a plurality of content items for which a content acquisition request has been input to display apparatus 200 via user command receiving section 205. Specifically, content screen display section 2041B controls the display position and display size in an overall screen area for a plurality of content screens that display respective content items so that each content display screen includes an occupied area that does not overlap another content screen. Also, content screen display section 2041B generates and outputs display data for performing superimposed display of a plurality of content screens upon an area larger than an occupied area based on a determination result of determination section 2043 described later herein. The display position, display size, and display format of a content screen will be described later herein.

Identification information display section 2042B adds identification information enabling a content screen to be identified to an occupied area. By this means, a user's awareness can be guided toward an occupied area, enabling the time required for a user to identify desired content to be shortened. For example, in the same way as identification information display section 2042, identification information display section 2042B controls the display position and display format of content information, and displays content information in an occupied area. The identification information display method used by identification information display section 2042B will be described later herein.

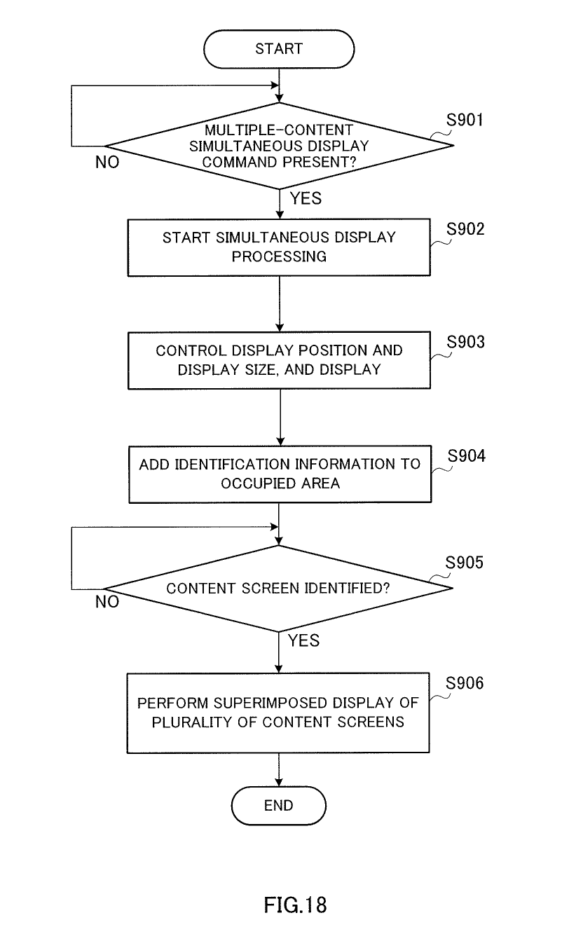

Next, the operation of display control section 204B will be described using FIG. 18. FIG. 18 is a flowchart showing the operation of display control section 204B.

Content screen display section 2041B determines the presence or absence of a multiple-content simultaneous display command (step S901). Content screen display section 2041B determines the presence or absence of a multiple-content simultaneous display command based on a default setting or user setting. As a default setting example, content screen display section 2041B determines that there is a multiple-content simultaneous display command if, for example, a simultaneous display command for a plurality of content screens is input via user command receiving section 205 by means of a user remote operation or the like. Specifically, content screen display section 2041B determines that there is a simultaneous display command for a plurality of content screens if user command receiving section 205 receives another content display command, a zapping command, or the like, during display of a particular content screen.

In the event of determining that there is a multiple-content simultaneous display command, content screen display section 2041B starts simultaneous display processing (step S902).

First, content screen display section 2041B performs display by controlling the display position and display size in an overall screen area for a plurality of content screens that display respective content items so that each content display screen includes an occupied area that does not overlap another content screen (step S903).

Any of [Display Method #1] through [Display Method #3] described in Embodiment 1, for example, can be used as a setting method for each occupied area.

For example, with [Display Method #1], as shown in FIG. 7, in the case of content identifier “CONTENT-ID-0001” of title “Sport #1,” an occupied area is provided at the left edge and lower part of the screen, and in the case of content identifier “CONTENT-ID-0004” of title “Documentary #1,” an occupied area is provided at the right edge and upper part of the screen.

With [Display Method #2], for “CONTENT-ID-0001” (titled “Sport #1”) contents, an occupied area is provided on the left side of the display section 203 screen, and content identifier “CONTENT-ID-0004” (titled “Documentary #1”) contents, an occupied area is provided on the right side of the display section 203 screen.

With [Display Method #3], an occupied area is provided for each content item on a frame timing group basis. That is to say, with [Display Method #3], occupied areas are used that do not overlap another content screen in the time domain.

In this way, content screen display section 2041B controls display positions and display sizes in the overall screen area of display section 203 so as to include occupied areas that do not overlap another content screen. By this means, users can identify their desired content by focusing on an occupied area.

Identification information display section 2042B adds identification information enabling a content screen to be identified to an occupied area (step S904). By this means, a user's awareness can be guided toward an occupied area.

As a method of adding identification information, identification information display section 2042B may display content information in an occupied area in the same way as identification information display section 2042. Provision may also be made for identification information display section 2042B to color occupied areas differently, or flash the frames of occupied areas. Furthermore, provision may also be made for identification information display section 2042B to generate speech or the like, linked to video of a content screen, from a speaker near an occupied area in which that content screen is displayed among speakers forming a stereo system (not shown in FIG. 17) provided on either side of display section 203.

In this way, content information, an occupied area frame color, flashing of an occupied area frame, or speech or the like linked to video of a content screen displayed in an occupied area, is added to an occupied area by identification information display section 2042B as identification information. By this means, a user's awareness can be guided toward an occupied area, enabling the time required for a user to identify a content screen to be shortened. However, if information facilitating content screen identification (for example, a program title or the like) is included in an occupied area, identification information display section 2042B need not necessarily add identification information, and step S904 may be omitted.

Determination section 2043 determines whether or not a user has identified a desired content screen by means of user interaction using user command receiving section 205, for example (step S905).

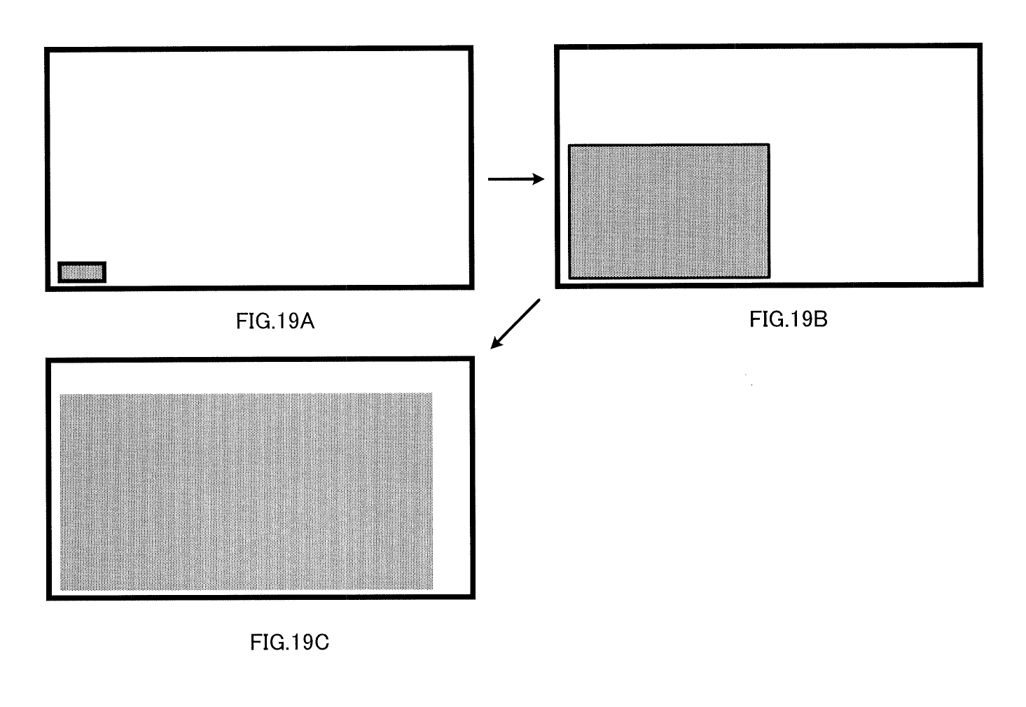

When a user identifies a desired content screen, content screen display section 2041B performs superimposed display of a plurality of content screens (step S906). The transparent display method or frame rate method described in Embodiment 1, for example, can be used as the superimposed display method. When a user identifies one content screen displayed in a predetermined occupied area, identification information display section 2042B performs field-of-view enlargement support for the user. Specifically, identification information display section 2042B displays a message prompting field-of-view enlargement on display section 203. Provision may also be made for identification information display section 2042B to gradually enlarge the frame of each occupied area to a large area. Furthermore, provision may also be made, as shown in FIG. 19A, FIG. 19B, and FIG. 19C, for example, for identification information display section 2042B to enlarge a display area while making the occupied area frame fainter in the order of FIG. 19A, FIG. 19B, and FIG. 19C, and to finally delete the occupied area frame when the display area reaches its maximum size. By this means, when an occupied area and content screen area are equal, a user can smoothly enlarge his field of view from an occupied area to a large area.

As described above, in this embodiment, content screen display section 2041B controls the display position and display size in an overall screen area for a plurality of content screens that display respective content items so that each content display screen includes an occupied area that does not overlap another content screen. Here, content screen display section 2041B generates and outputs display data for performing superimposed display of a plurality of content screens upon an area larger than an occupied area based on a determination result of determination section 2043 described later herein. By this means, a plurality of users can view their respective desired content items simultaneously while suppressing a sacrifice of screen size. A method other than [Display Method #1] through [Display Method #3] may also be used as an occupied area setting method. Below, [Display Method #4] will be described as another display method.

[Display Method #4]

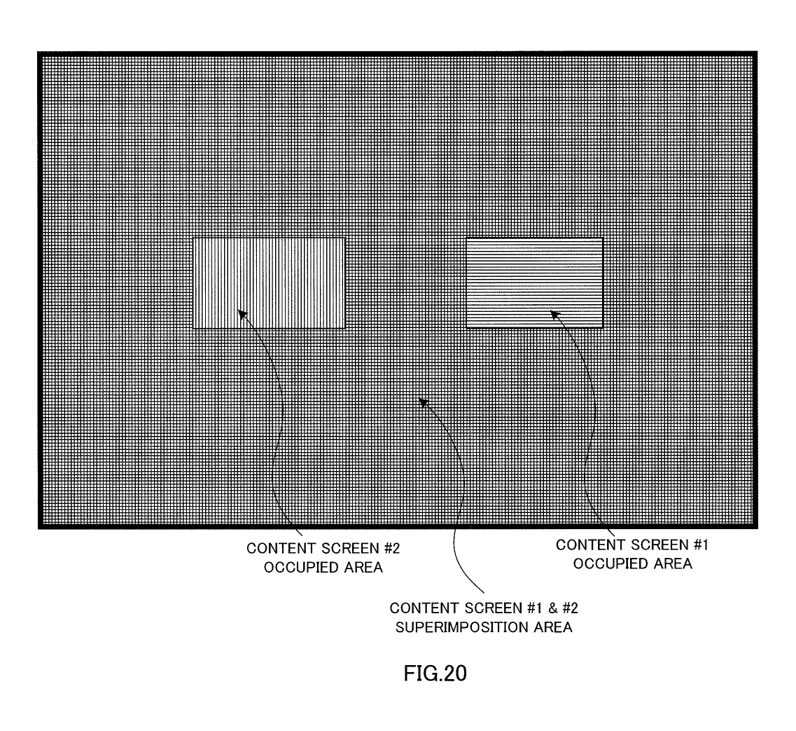

Display processing will be described below using FIG. 20, taking a case in which there is a command to display two content items as an example. FIG. 20 is an example of a case in which a simultaneous display command is received for two content screens, content screen #1 and content screen #2.

Content screen display section 2041B sets specific areas of display section 203 as occupied areas displaying the respective content screens. In the example shown in FIG. 20, content screen display section 2041B secures a content screen #1 occupied area at a position approximately ⅓ to the right of the center of the display section 203 screen, and displays content screen #1 in that occupied area. Also, content screen display section 2041B secures a content screen #2 occupied area at a position approximately 1/3 to the left of the center of the display section 203 screen, and displays content screen #2 in that occupied area.

Provision may also be made for content screen display section 2041B to set the position and size of the above occupied areas based on “Content type.” Here, as explained above, “Content type” indicates a content genre, attribute, or the like.

Specifically, content screen display section 2041B may set an area that allows a user to identify a content screen more easily as an occupied area based on “Content type.” For example, when the content type is a sport such as baseball, provision may be made for content screen display section 2041B to set an area in which a baseball score is displayed as an occupied area, and to display a baseball score in that occupied area. Also, when the content type is a variety show hosted by a compere, for example, provision may be made for content screen display section 2041B to set an area in which the compere is normally displayed as an occupied area, and to display the compere in that occupied area. Alternatively, provision may be made for content screen display section 2041B to perform image recognition on a content screen, set an area in which the compere is displayed as an occupied area, and display the compere in that occupied area. Furthermore, provision may also be made for content distribution server 100 to specify beforehand an area in which content screen characteristics are best displayed as an occupied area based on “Content type,” and to distribute information on that occupied area as metadata together with a content screen.

Provision may also be made for content screen display section 2041B to set a text display area or an area with little movement as an occupied area. Examples of a text display area include a program title, news, movie, or suchlike subtitle display area. Having content screen display section 2041B use a text display area or an area with little movement as an occupied area and display a content screen in that occupied area makes it easier for a user to direct his awareness toward an occupied area.

Provision may also be made for content screen display section 2041B to set the position and size of above-described occupied areas based on the characteristics of content screens displayed in a superimposed fashion. For example, with an area in which there is little change of color, such as an area of sky or sea, even if part of the area is not displayed, this will probably have little effect on improvement of the content screen recognition rate. Thus, provision may be made for content screen display section 2041B to provide an occupied area of a second content screen in an area in which there is little change of color in a first content screen based on content screen color phase.

If another content screen is superimposed on an area of extremely low brightness, or, reversely, an area of extremely high brightness, it can be expected to be difficult to see. Thus, provision may be made for content screen display section 2041B to provide an occupied area of a second content screen in an area of extremely low or high brightness in a first content screen based on content screen brightness. An example of extremely low brightness is video shot in the dark, and an example of extremely high brightness is video shot under lights.

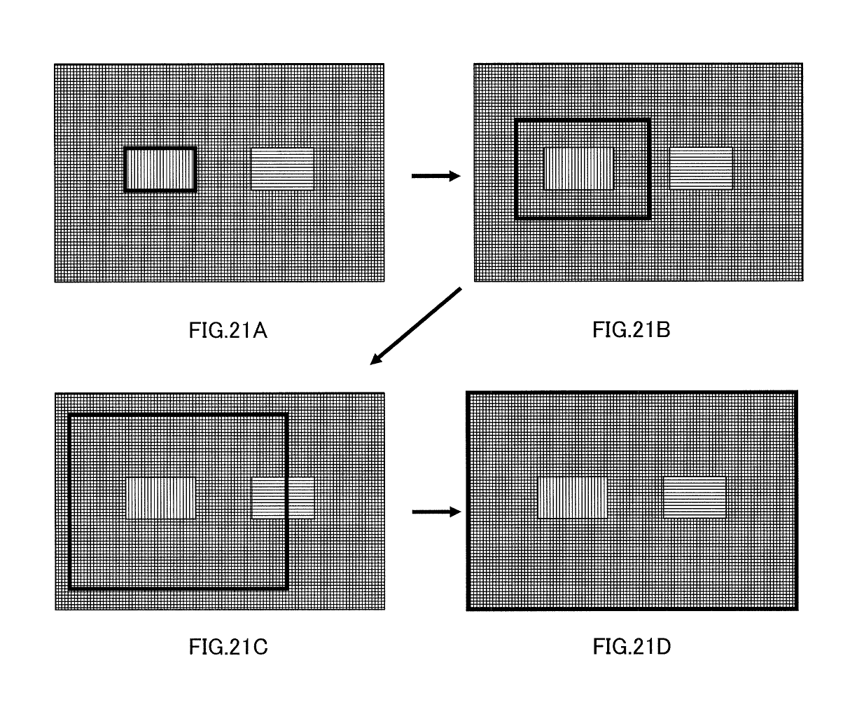

When an occupied area and content screen area are different, as described in [Display Method #4], identification information display section 2042B may perform field-of-view enlargement for a user in the following way. For example, as shown in FIG. 21, identification information display section 2042B may enlarge only the frame of an occupied area, without changing the size of a content screen itself, in the order of FIG. 21A, FIG. 21B, FIG. 21C, and FIG. 21D. By this means, even if an occupied area and content screen area are different, a user can enlarge his field of view smoothly from an occupied area to a large area in which a content screen is already displayed.

Identification information display section 2042B may also gradually make the frame of an occupied area fainter as that frame is enlarged. Furthermore, identification information display section 2042B may enlarge only the frame of an occupied area, and reduce the occupied area as that frame enlargement proceeds, so that the occupied area disappears and the entire content screen is superimposed when that frame reaches its maximum size. By this means, a user can enlarge his field of view smoothly from an occupied area to a large area.

The disclosure of Japanese Patent Application No. 2009-185840, filed on Aug. 10, 2009, including the specification, drawings and abstract, is incorporated herein by reference in its entirety.

### INDUSTRIAL APPLICABILITY

The present invention is suitable for use as a content distribution service receiving terminal using package media such as DVDs, a content display terminal using digital broadcasting, CATV (Common Antenna Television), the Internet, or the like, and so forth.

### REFERENCE SIGNS LIST

100 Content distribution server
101, 201 Communication section
102 Content acquisition and transmission section
111 Content storage section
112 Content information storage section
200, 200A, 200B Display apparatus
202 Content reception and acquisition section
203 Display section
204, 204B Display control section
2041, 2041B Content screen display section
2042, 2042B Identification information display section
2043 Determination section
205 User command receiving section
211 Content storage section
212 Content information storage section
213 Display control rule storage section
300 Communication path

1. A display control apparatus that controls display of a plurality of content items, said display control apparatus comprising a content screen display section that controls a display position and display size in an overall screen area for a plurality of content screens that display respective content items so that each content display screen includes an occupied area that does not overlap another content screen, and generates and outputs display data of said plurality of content screens; and
a determination section that determines whether or not one content screen displayed in a predetermined occupied area from among a plurality of said occupied areas has been identified by a user, wherein said content screen display section generates display data for performing superimposed display of said plurality of content screens upon an area larger than said occupied area based on a determination result in said determination section.

2. The display control apparatus according to claim 1, wherein said content screen display section, when said user identifies one content screen displayed in said predetermined occupied area, gradually enlarges a frame of said occupied area to said large area.

3. The display control apparatus according to claim 1, wherein said content screen display section, when said user identifies one content screen displayed in said predetermined occupied area, displays a message prompting said user to perform field-of-view enlargement in part of said overall screen area.

4. The display control apparatus according to claim 1, further comprising an identification information display section that adds identification information enabling identification of said each content screen in said occupied area.

5. The display control apparatus according to claim 1, wherein said content screen display section performs superimposed display of said plurality of content screens in said large area by performing transparent display of said plurality of content screens or alternately displaying said each content screen at a rate that is several times a frame rate.

6. The display control apparatus according to claim 1, wherein said content screen display section sets said occupied area based on a genre or attribute of said each content item.

7. The display control apparatus according to claim 1, wherein said content screen display section sets said occupied area based on a text display area, hue, or brightness of said each content screen.

8. A display control method that controls display of a plurality of content items, said display control method comprising:
a screen display step of controlling a display position and display size in an overall screen area for a plurality of content screens that display respective content items so that each content display screen includes an occupied area that does not overlap another content screen, and generating and outputting display data of said plurality of content screens; and
a determination step of determining whether or not one content screen displayed in a predetermined occupied area from among a plurality of said occupied areas has been identified by a user, wherein said screen display step generates display data for performing superimposed display of said plurality of content screens upon an area larger than said occupied area based on a determination result in said determination step.
